(19) United States
(12) Patent Application Publication
(10) Pub. No.: US 2003/0096629 A1
(43) Pub. Date: May 22, 2003

(54) Systems and methods for monitoring RF power

(76) Inventors: Brig Barnum Elliott, Arlington, MA (US); Anthony Michel, Lexington, MA (US)

Correspondence Address: Leonard C. Suchyta, c/o Christian Andersen, Verizon Services Group, 600 Hidden Ridge, HQE03H01, Irving, TX, 75038, US

(21) Appl. No.: 09/990,648

(22) Filed: Nov. 21, 2001

(51) Int. Cl. H04B 7/00

(52) U.S. Cl. 455/522; 455/67.1; 455/127

(57) ABSTRACT

A system for archiving radio frequency (RF) power levels measured at distributed locations in a network (115) includes multiple RF power monitoring devices (105a-105n) and an archival server (120). Each of the power monitoring devices (105a-105n) measures an RF power level at a location of the device, and transmits one or more packets comprising the measured RF power level and a unique identifier associated with the device across a network (115). The archival server (120) receives the packets from each of the plurality of RF power monitoring devices (105a-105n), and stores the measured RF power levels and associated unique identifiers from the packets in a power history database.

### FIELD OF THE INVENTION

The present invention relates generally to measurement and monitoring systems and, more particularly, to systems and methods for monitoring radio frequency power.

### BACKGROUND OF THE INVENTION

Cellular telephones are very rapidly growing in popularity. For example, there are now estimated to be about 100 million cell phone users in the United States alone. Furthermore, there are far more cell-phone users abroad and many indications that cell phones will entirely supplant “wired” phones in the coming years.

Accompanying this growth, though, are increasing concerns regarding possible health issues involved with the use of cell phones. Many people are uncomfortable with the idea of placing radio transmitters very close to their brain. Some portion of the population also is uncomfortable with the idea of any artificial radio frequency (RF) transmissions in their immediate vicinity. Although there are no scientific indications to date that the RF emissions of cell phones (or other wireless devices) cause health problems, the American Cell-Phone Industry Group (CTIA) has recently decided that all new cell phones should be labeled with the maximum RF power that the phone can emit. This labeling is for the purpose of reassuring consumers that the cell phones they use are within the FCC-mandated power limits and, thus, are safe.

With the increasing concerns regarding cell phone RF emissions there, therefore, exists a need for systems and methods that permit the monitoring of RF power levels within localized areas. Such localized monitoring would enable individuals or entities to assure the safety of specific areas from excessive RF power levels.

### SUMMARY OF THE INVENTION

Systems and methods consistent with the present invention address this and other needs by providing an easy to use, portable monitoring device that can indicate levels of RF power at localities of interest. Additionally, systems and methods consistent with the present invention provide a monitoring device that can measure RF power levels at specific locations and transmit the measured RF power levels to a server via a network, such as, for example, the Internet. The RF power levels received at the server may be archived as RF power histories for future retrieval.

In accordance with the purpose of the invention as embodied and broadly described herein, a method of archiving radio frequency (RF) power profiles includes measuring an RF power level at an RF power monitoring device, transmitting the measured RF power level and a unique identifier associated with the RF power monitoring device to a measurement archival server across a network, and storing the measured RF power level and the unique identifier as a data record in the measurement archival server.

In another implementation consistent with the present invention, a data structure encoded on a computer readable medium includes first data comprising a unique identifier associated with a radio frequency (RF) power monitoring device interconnected with a network, and second data comprising a RF power level measured at the RF power monitoring device.

In a further implementation consistent with the present invention, a radio frequency power monitoring device includes a frequency selector configured to pass one or more radio frequency bands of a received radio frequency signal; a power estimator configured to estimate a power level of the received radio frequency signal; a memory; a processing unit configured to receive the power level from the power estimator, store the power level in the memory, and construct a record comprising the power level and a unique identifier associated with the radio frequency power monitoring device; and a network interface configured to transmit the record to a measurement collection server across a network.

In an additional implementation consistent with the present invention, a method of monitoring radio frequency (RF) power at a hand-held RF power monitoring device includes receiving RF signals, frequency selecting the received RF signals, estimating a power level associated with the frequency selected RF signals, and activating at least one of a high, medium and low RF power level indicator based on the estimated power level.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary network in which systems and methods, consistent with the present invention, may be implemented;

FIG. 2 illustrates exemplary components of a RF power-monitoring device consistent with the present invention;

FIG. 3 illustrates an exemplary configuration of a hand-held RF power-monitoring device consistent with the present invention;

FIG. 4 illustrates another exemplary configuration of a hand-held RF power-monitoring device consistent with the present invention;

FIG. 5 illustrates exemplary components of the detector and power estimator and RF intensity display of FIG. 2 consistent with the present invention;

FIG. 6 illustrates an exemplary configuration of a wall-mounted RF power-monitoring device consistent with the present invention;

FIG. 7 illustrates exemplary components of the RF power-monitoring device of FIG. 6 consistent with the present invention;

FIG. 8 illustrates exemplary components of the measurement collection server of FIG. 1 consistent with the present invention;

FIG. 9 illustrates an exemplary database stored in the measurement collection server of FIG. 8 consistent with the present invention;

FIGS. 10A and 10B illustrate exemplary records of the database of FIG. 9 consistent with the present invention; and

FIG. 11 is a flow chart that illustrates exemplary system processing consistent with the present invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with the present invention provide mechanisms for measuring RF power levels at localities of interest. Additionally, systems and methods consistent with the present invention provide mechanisms for measuring RF power levels at specific locations and transmitting the measured RF power levels to a server via a network, such as, for example, the Internet. The RF power levels received at the server may be archived as RF power histories for future retrieval.

### Exemplary Network

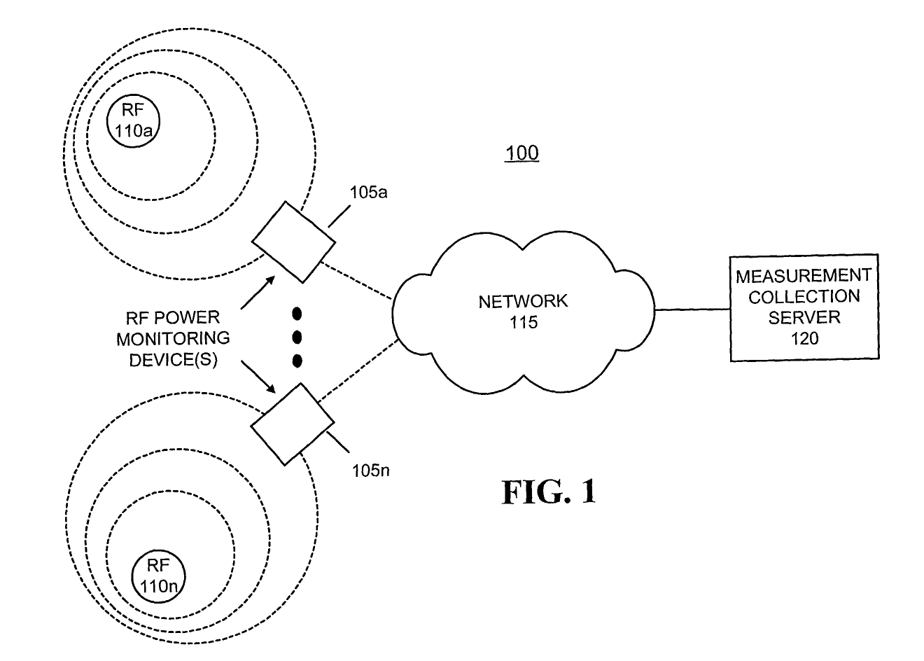

FIG. 1 illustrates an exemplary network 100 in which systems and methods, consistent with the present invention, may operate to monitor RF power. Network 100 includes one or more RF sources 110a-110n and one or more RF power monitoring devices 105a-105n. RF sources 110a-110n may include any type of RF emitter, including, for example, wireless telephony transmitters (e.g., wireless base stations and cellular phones). Network 100 may further include a sub-network 115 and a measurement collection server 120. Sub-network 115 can include one or more networks of any type, including a local area network (LAN), metropolitan area network (MAN), wide area network (WAN), Internet, or Intranet. Measurement collection server 120 may store RF power measurements received from RF power monitoring devices 105a-105n via sub-network 115. RF power monitoring devices 105a-105n may optionally interconnect with sub-network 115 via wired or optical connection links.

### Exemplary RF Power Monitoring Device

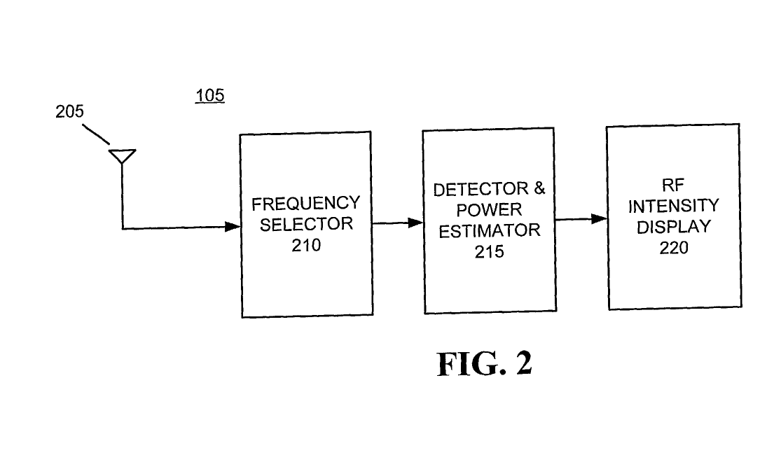

FIG. 2 illustrates an exemplary diagram, consistent with the present invention, of RF power-monitoring device 105. Device 105 may include an antenna 205, a frequency selector 210, a detector and power estimator 215, and a RF intensity display 220. Antenna 205 may include a conventional antenna that facilitates the reception of RF signals. Frequency selector 210 may include circuitry for filtering the RF signals received at antenna 205 and passing one or more selected bands of frequencies to detector and power estimator 215. For example, frequency selector 210 may be configured to pass frequencies in “cell phone” bands, such as 900 MHz or 1900 MHz bands. Additionally, frequency selector 210 may be configured to pass frequencies in the wireless LAN bands, such as, for example, the ISM band at 920 MHz or the Nil band at 5 GHz. Detector and power estimator 215 may include circuitry for providing an estimation of the RF power of signals received from frequency selector 210. RF intensity display 220 may include circuitry and mechanisms for displaying the estimated RF power levels of received RF signals.

### Exemplary Hand-Held RF Power Monitoring Device

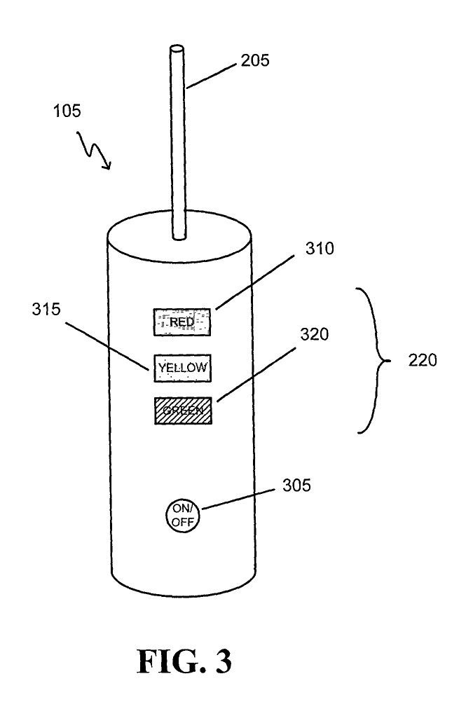

FIG. 3 illustrates an exemplary hand-held configuration of RF power monitoring device 105 consistent with the present invention. RF power monitoring device 105 may comprise a pen-shaped cylindrical housing that includes a protruding antenna 205, RF intensity display 220 and an ON/OFF switch 305. RF intensity display 220 may further include RF power level Light-Emitting Diodes (LEDs), such as “RED” LED 310, “YELLOW” LED 315, and “GREEN” LED 320. “RED” LED 310 may indicate a high level of RF power received by RF power monitoring device 105. “YELLOW” LED 315 may indicate a medium level of RF power received by RF power monitoring device 105. “GREEN” LED 320 may indicate a low level of RF power received by RF power monitoring device 105. Alternatively, RF intensity display 220 may include monochromatic LEDs or Liquid Crystal Displays (LCDs). ON/OFF switch 305 may selectively apply power to device 105 via an internal (e.g., battery) or external power supply.

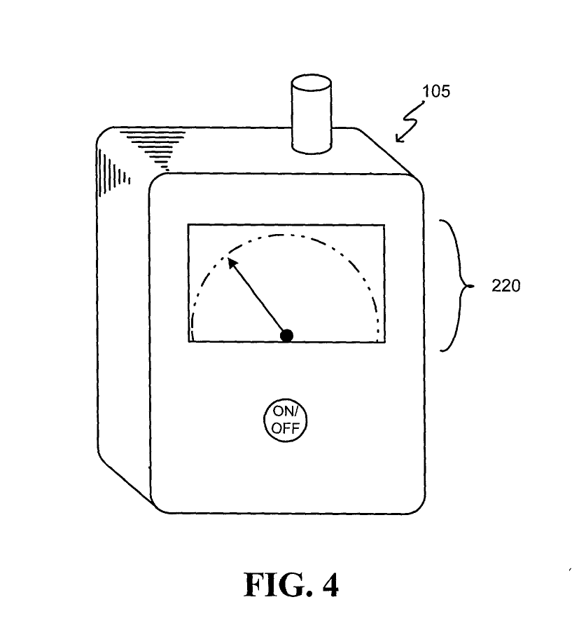

FIG. 4 illustrates another exemplary hand-held configuration of RF power monitoring device 105 consistent with the present invention. In this exemplary configuration, RF power monitoring device 105 may comprise a rectangular housing that includes an analog meter for the RF intensity display 220.

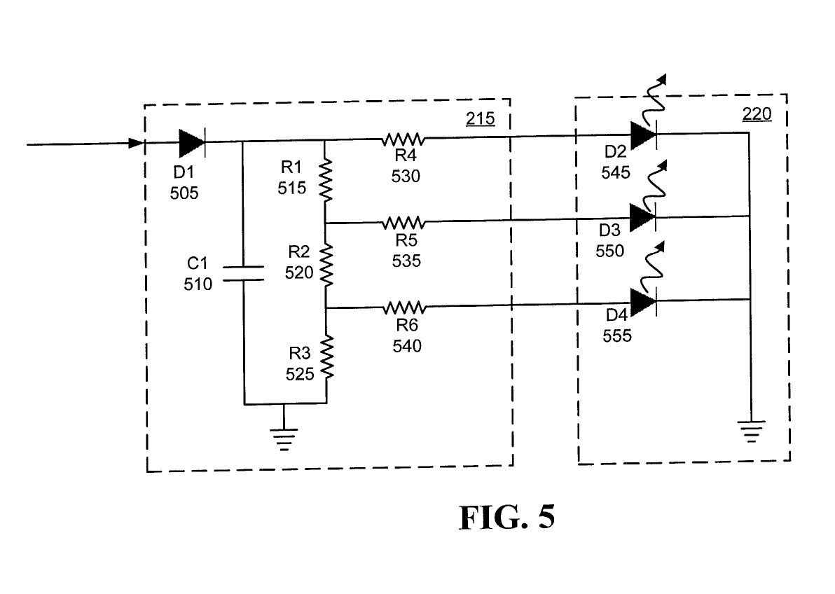

FIG. 5 illustrates an exemplary circuit diagram of the detector and power estimator 215 and RF intensity display 220 of FIG. 2. Detector and power estimator 215 may include diode D1 505, capacitor C1 510 and resistors R1 515, R2 520, R3 525, R4 530, R5 535 and R6 540. Diode D1 505 rectifies RF signals received from antenna 205. Capacitor C1 510 and resistors R1 515, R2 520 and R3 525 form a low-pass filter, with the time constant of the filter set by capacitor C1 510. The value of C1 510 can be selected such that (R1+R2+R3)*C1>10⁻³. Resistors R1 515, R2 520 and R3 525 further form a resistive voltage divider for supplying voltages to RF intensity display 220. The values of R1 515, R2 520 and R3 525 can be selected to set specific signal levels for “low,” “medium,” and “high” signal intensity. RF intensity display 220 may include LEDs D2 545, D3 550 and D4 555 that indicate RF signal intensity. Resistors R4 530, R5 535 and R6 540 can be selected to set the brilliance of LEDs D2 545, D3 550 and D4 555, respectively.

### Exemplary Wall-Mounted RF Power Monitoring Device

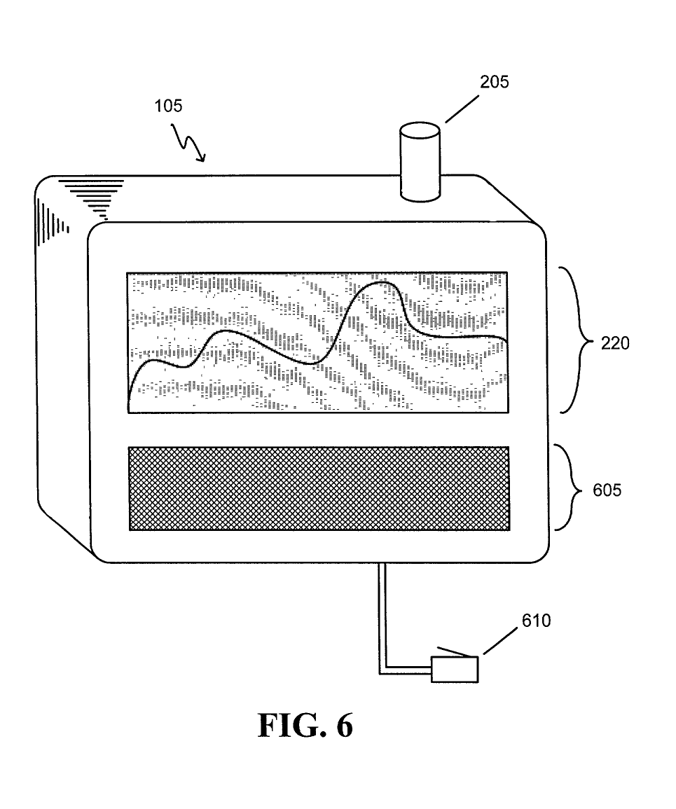

FIG. 6 illustrates an exemplary wall-mounted configuration of RF power monitoring device 105 consistent with the present invention. RF power monitoring device 105 may include a rectangular-shaped housing that further includes a protruding antenna 205, RF intensity display 220, a loudspeaker 605 and an interface cable 610. RF intensity display 220 may include a pixel-oriented display, such as, for example, a LCD or video display. RF intensity display 220 can draw continuous scrolling graphs of RF power levels received at antenna 205 as monitored over a time interval. For example, RF intensity display 220 may show the RF power as received within the past minute. The height of the displayed curve indicates the RF power as measured over a particular interval. RF intensity display 220, thus, indicates recent historical RF power levels. Loudspeaker 605 may include conventional mechanisms for outputting an audio alarm signal when received RF power exceeds some specified maximum value. Interface cable 610 may connect RF power monitoring device 105 to network 115.

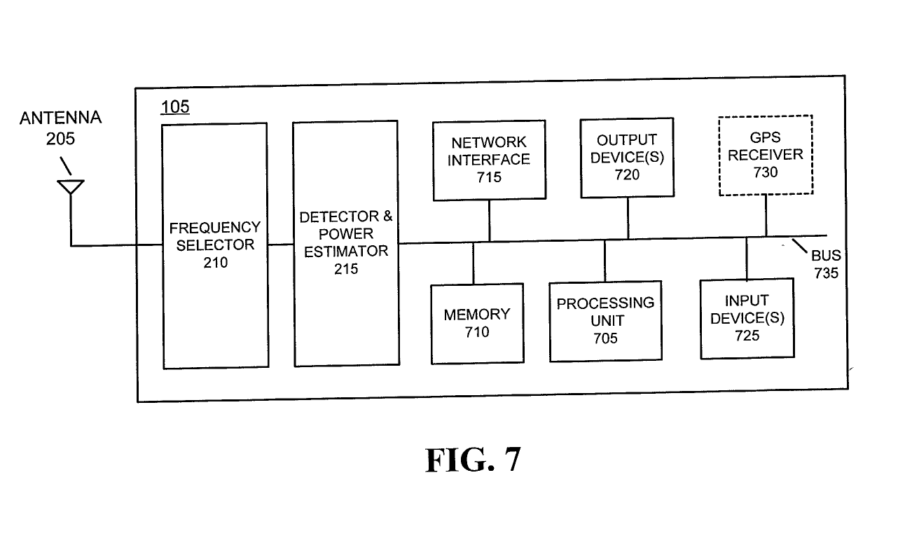

FIG. 7 illustrates an exemplary diagram, consistent with the present invention, of the RF power-monitoring device 105 shown in FIG. 6. RF power monitoring device 105 may include an antenna 205, a frequency selector 210, a detector and power estimator 215, a processing unit 705, a memory 710, a network interface 715, output device(s) 720, input device(s) 725, a Global Position System (GPS) receiver 730, and a bus 735. Antenna 205 may include a conventional antenna that facilitates the reception of RF signals. Frequency selector 210 may include circuitry for filtering the RF signals received at antenna 205 and passing selected bands of frequencies to detector and power estimator 215. For example, frequency selector 210 may be configured to pass frequencies in “cell phone” bands, such as 900 MHz or 1900 MHz bands. Additionally, frequency selector 210 may be configured to pass frequencies in the wireless LAN bands, such as, for example, the ISM band at 920 MHz or the NIL band at 5 GHz. Detector and power estimator 215 may include circuitry for providing an estimation of the RF power of signals received from frequency selector 210.

Processing unit 705 may perform data processing functions for inputting, outputting, and processing of RF power measurement data received from detector and power estimator 215. Memory 710 provides permanent, semi-permanent, or temporary working storage of RF power measurement data and instructions for use by processing unit 705 in performing processing functions. Memory 710 may include large-capacity storage devices, such as a magnetic and/or optical recording device. Network interface 715 may include conventional circuitry for interfacing RF power monitoring device 105 with an external network, such as sub-network 115. Output device(s) 720 may include conventional mechanisms for outputting data in video, audio, and/or hard copy format. Output device(s) 720 may include, for example, RF intensity display 220 and loudspeaker 605. Input device(s) 725 permit entry of data into RF power monitoring device 105 and may include a user interface (not shown). GPS receiver 730 may include conventional circuitry for receiving GPS signals and determining a geographic location of RF power monitoring device 105. Bus 735 interconnects the various components of RF power monitoring device 105 to permit the components to communicate with one another.

### Exemplary Measurement Collection Server

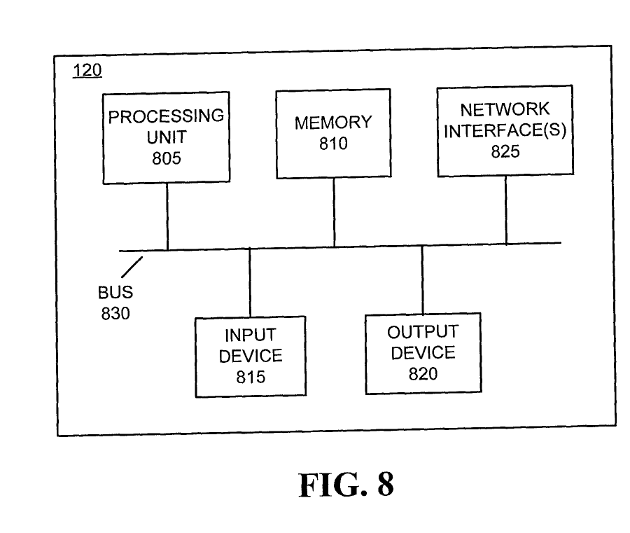

FIG. 8 illustrates exemplary components of measurement collection server 120 consistent with the present invention. Measurement collection server 120 may include a processing unit 805, a memory 810, an input device 815, an output device 820, network interface(s) 825 and a bus 830. Processing unit 805 may perform all data processing functions for inputting, outputting, and processing of data. Memory 810 may include Random Access Memory (RAM) that provides temporary working storage of data and instructions for use by processing unit 805 in performing processing functions. Memory 810 may additionally include Read Only Memory (ROM) that provides permanent or semi-permanent storage of data and instructions for use by processing unit 805. Memory 810 can also include large-capacity storage devices, such as a magnetic and/or optical device.

Input device 815 permits entry of data into measurement collection server 120 and may include a user interface (not shown). Output device 820 permits the output of data in video, audio, or hard copy format. Network interface(s) 825 interconnect measurement collection server 120 with network 115. Bus 830 interconnects the various components of measurement collection server 120 to permit the components to communicate with one another.

### Exemplary Measurement Collection Server Database

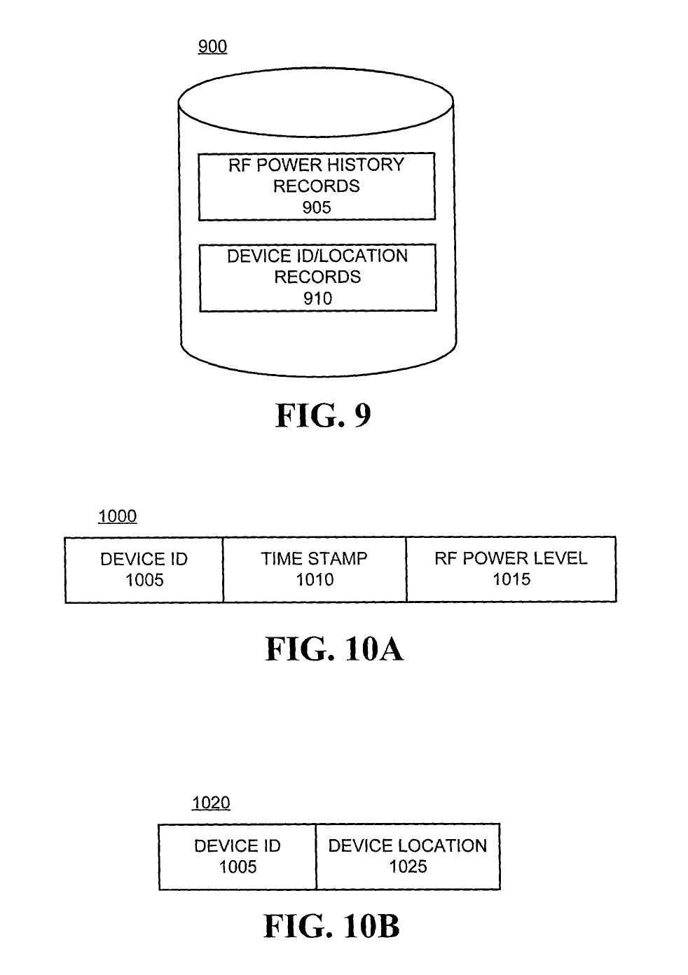

FIG. 9 illustrates an exemplary database 900 that may be stored in memory 810 of measurement collection server 120. Database 900 may include RF power history records 905 associated with RF power monitoring devices 105a-105n interconnected with sub-network 115. Database 900 may further include RF power monitoring device identifier/location records 910 that map unique identifiers associated with each RF power monitoring device 105a-105n to a geographic location of each device 105a-105n.

FIG. 10A illustrates an exemplary record 1000 of RF power history records 905. Record 1000 may include a device identifier 1005, a time stamp 1010, and a RF power level 1015. Device identifier 1005 may include a unique identifier associated with the RF power-monitoring device 105a-105n that measured the RF power level 1015. Device identifier 1005 may include a unique device serial number, a uniquely assigned numeric/alpha-numeric identifier, or a network address (e.g., an IP address) associated with the RF power-monitoring device 105a-110n that has sent an RF power level to measurement collection server 120. Time stamp 1010 specifies a time that an RF power level was measured at RF power monitoring device 105a-110n. RF power level 1015 indicates the RF power level measured at the RF power-monitoring device 105a-105n associated with IP address 1005 at the time specified by time stamp 1010.

FIG. 10B illustrates an exemplary record 1020 of device ID/location records 910. Record 1020 may include the device identifier 1005 and a device location 1025. The device identifier 1005 includes an identifier associated with the RF power monitoring device 105a-105n that has sent an RF power level to measurement collection server 120. Device location 1030 includes location data associated with the device identified by device identifier 1005. Device location 1030 may include location data derived from GPS signals received at RF power monitoring device 105a-105n. Device location 1030 may further include any type of location data that identifies a geographic location of RF power monitoring device 105a-105n.

### Exemplary System Processing

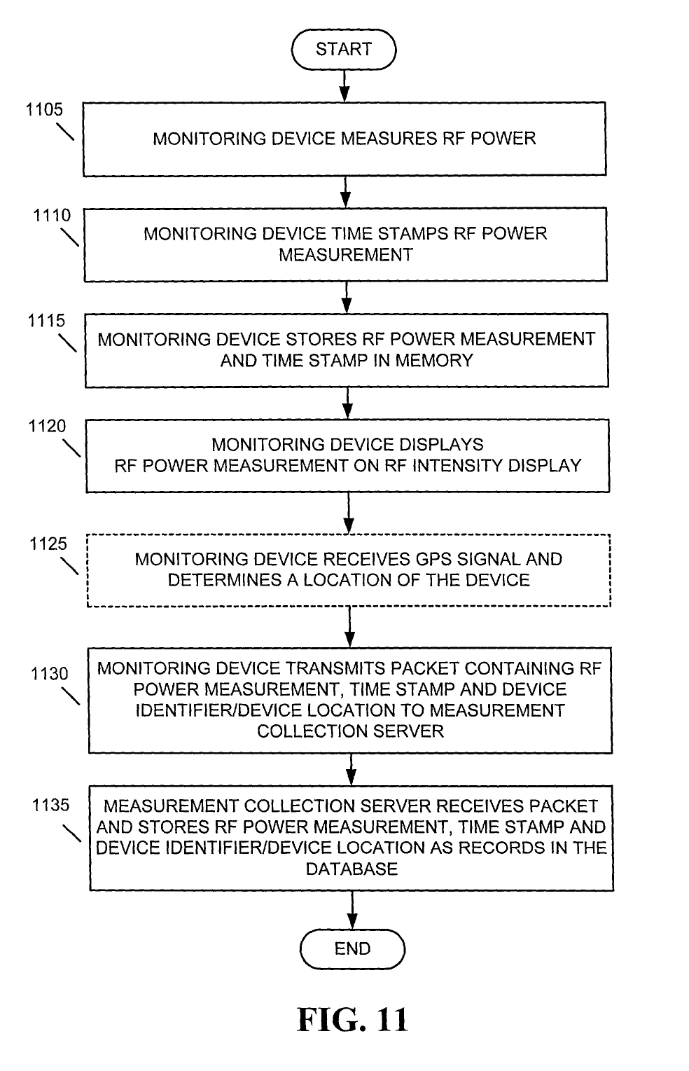

FIG. 11 is a flowchart that illustrates exemplary processing, consistent with the present invention, for measurement and transfer of RF power measurements from RF power monitoring device 105 to measurement collection server 120. Processing may begin with RF power monitoring device 105 measuring an RF power level [step 1105]. RF power monitoring device 105 may then time stamp the RF power measurement [step 1110]. RF power monitoring device 105 may further store the RF power measurement and time stamp in memory 710 [step 1115]. RF power monitoring device 105 may then display the RF power measurement on the RF intensity display of output device(s) 720 [step 1120].

RF power monitoring device 105 may, optionally, receive a GPS signal at GPS receiver 730 and determine a geographic location of the device in accordance with conventional techniques [step 1125]. RF power monitoring device 105 may then transmit the RF power measurement, the associated time stamp, the device 105's device identifier 1005, and, optionally, device 105's determined device location 1025 to measurement collection server 120 via sub-network 115 [step 1130]. This information may be transmitted, for example, as one or more packets of data. Measurement collection server 120 may receive the transmitted information and store the RF power level measurement 1015, time stamp 1010, and device identifier 1005 as a record in power history records 905 of database 900, and device identifier 1005 and device location 1025 as a record in device ID/location records 910 [step 1135]. Device location 1025 may include a location associated with device identifier 1005 that has been previously stored in server 120. Steps 1105-1135 can be selectively repeated to create a RF power profile associated with a particular RF power-monitoring device 105 in database 900. This RF power profile may be used, for example, by cellular service providers for cell planning or to provide evidence that the emitted RF power at designated localities does not exceed specified maximum values.

### Conclusion

As described above, systems and methods consistent with the present invention provide mechanisms for measuring RF power levels at localities of interest. Additionally, systems and methods consistent with the present invention provide mechanisms for transmitting the measured RF power levels to a server via a network where the power levels may be archived as RF power histories for future retrieval.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in hardware and others in software, other configurations may be possible. Also, while series of steps have been described with regard to FIG. 11, the order of the steps is not critical. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

What is claimed is:

1. A radio frequency power monitoring device, comprising:
a frequency selector configured to pass one or more radio frequency bands of a received radio frequency signal;
a power estimator configured to estimate a power level of the received radio frequency signal;
a memory;
a processing unit configured to:
receive the power level from the power estimator,
store the power level in the memory, and
construct a record comprising the power level and a unique identifier associated with the radio frequency power monitoring device; and
a network interface configured to transmit the record to a measurement collection server across a network.

2. The device of claim 1, the power estimator comprising:
a rectifier configured to rectify the received radio frequency signal; and
a filter configured to pass one or more bands of frequencies, the filter comprising at least one capacitive device and a plurality of resistive devices, the plurality of resistive devices forming a voltage dividing network that supplies portions of the rectified radio frequency signal to a plurality of power level indicators.

3. The device of claim 1, further comprising:
a display device configured to indicate the power level of the received radio frequency signal.

4. The device of claim 3, wherein the display device comprises the plurality of power level indicators, each of the plurality of power level indicators indicating at least one of a high, medium, and low power level.

5. The device of claim 1, wherein the record is transmitted as one or more packets over an IP network.

6. The device of claim 3, wherein the display device comprises at least one of a liquid crystal display device and a video display device.

7. The device of claim 1, wherein the unique identifier comprises at least one of a device serial number, a device alphanumeric identifier and a network address.

8. The device of claim 7, wherein the network address comprises an IP address.

9. The device of claim 1, wherein the network comprises an IP network.

10. A method of archiving radio frequency (RF) power profiles, comprising:
measuring an RF power level at an RF power monitoring device to obtain a measured RF power level;
transmitting the measured RF power level and a unique identifier associated with the RF power monitoring device to a measurement archival server across a network; and
storing the measured RF power level and the unique identifier as a data record in the measurement archival server.

11. The method of claim 10, wherein the network comprises an IP network.

12. The method of claim 10, wherein the unique identifier comprises as least one of a device serial number, a device alphanumeric identifier and a network address.

13. The method of claim 12, wherein the network address comprises an IP address.

14. The method of claim 10, wherein the RF power level is associated with a wireless telephony frequency band.

15. A data structure encoded on a computer readable medium, comprising:
first data comprising a unique identifier associated with a radio frequency (RF) power monitoring device interconnected with a network; and
second data comprising an RF power level measured at the RF power monitoring device.

16. The data structure of claim 15, wherein the network comprises an IP network.

17. The data structure of claim 15, wherein the unique identifier comprises at least one of a device serial number, a device alphanumeric identifier and a network address.

18. The data structure of claim 17, wherein the network address comprises an IP address.

19. The data structure of claim 15, further comprising:
third data comprising a time stamp that indicates a time at which the RF power level was measured at the RF power monitoring device.

20. A system for archiving radio frequency (RF) power levels measured at distributed locations in a network, comprising:
a plurality of RF power monitoring devices, each configured to:
measure an RF power level at a location of the device, and
transmit one or more packets comprising the measured RF power level and a unique identifier associated with the device across a network; and
an archival server configured to:
receive the packets from each of the plurality of RF power monitoring devices, and
store the measured RF power levels and associated unique identifiers from the packets in a power history database.

21. A radio frequency measurement collection server, comprising:
a memory; and
a processing configured to:
receive messages transmitted from radio frequency power monitoring devices located at distributed locations in a network,
retrieve radio frequency power measurement data and unique identifier data from each of the received messages, the unique identifier data being associated with the radio frequency power monitoring device at which the radio frequency power was measured, and
store the radio frequency power measurement data and unique identifier data in the memory.

22. A circuit for measuring radio frequency power levels, comprising:
a rectifier configured to rectify an input radio frequency signal;
a filter configured to pass one or more bands of frequencies, the filter comprising at least one capacitive device and a plurality of resistive devices, the plurality of resistive devices forming a voltage dividing network that supplies portions of the rectified radio frequency signal to a plurality of power level indicators; and
a radio frequency intensity display configured to indicate a power level of the input radio frequency signal, the intensity display comprising the plurality of power level indicators, the plurality of power level indicators indicating high, medium, and low power levels.

23. The circuit of claim 22, wherein the plurality of power level indicators comprise light emitting diodes.

24. The circuit of claim 22, wherein the plurality of power level indicators comprise liquid crystal displays.

25. A system for archiving radio frequency (RF) power profiles, comprising:
means for measuring a RF power level at an RF power monitoring device to obtain a measured RF power level;
means for transmitting the measured RF power level and a unique identifier associated with the RF power monitoring device to a measurement archival server across a network, the unique identifier comprising at least one of a device serial number, a device alpha-numeric identifier and a network address; and
means for storing the measured RF power level and the unique identifier as a data record in the measurement archival server.

26. A method of monitoring radio frequency (RF) power at a hand-held RF power monitoring device, comprising:
receiving RF signals to obtain received RF signals;
frequency selecting the received RF signals to obtain frequency selected RF signals;
estimating a power level associated with the frequency selected RF signals; and
activating at least one of a high, medium and low RF power level indicator based on the estimated power level.

27. The method of claim 26, wherein the at least one of the high, medium and low RF power level indicators comprise light emitting diodes.

28. A hand-held radio frequency (RF) power monitoring device, comprising:
a frequency selector configured to pass one or more RF frequency bands of a received RF signal;
a power estimator configured to estimate a RF power level of the received RF signal; and
an RF intensity display configured to indicate a level of RF power associated with the received RF signal, wherein the RF intensity display comprises a plurality of indicators and wherein the plurality of indicators indicate high, medium and low RF power level based on the estimated RF power level.
